(19) United States
(12) Patent Application Publication
(10) Pub. No.: US 2009/0240814 A1
(43) Pub. Date: Sep. 24, 2009

(54) Unified pairing for wireless devices

(75) Inventors: Douglas K. Brubacher, Sammamish, WA (US); Ronald J. Ayala, Redmond, WA (US); Gary P. Raden, II, Redmond, WA (US); David J. Roth, Redmond, WA (US); Alain L. Michaud, Redmond, WA (US)

Correspondence Address: WOLF GREENFIELD (Microsoft Corporation);C/O WOLF, GREENFIELD & SACKS, P.C., 600 ATLANTIC AVENUE, BOSTON, MA, 02210-2206, US

(73) Assignee: Microsoft Corporation, Redmond, WA (US)

(21) Appl. No.: 12/077,304

(22) Filed: Mar. 18, 2008

(51) Int. Cl. G06F 15/16

(52) U.S. Cl. 709/227

(57) ABSTRACT

A framework for users to connect to wireless devices, regardless of the underlying wireless technology. The framework has a modular structure, including discovery handlers, pairing handlers, and pairing ceremony modules. Discovery and pairing handlers are specific to each wireless technology, enabling discovery of wireless devices, and connection to the device. Pairing ceremony modules are technology independent, and may be invoked by any pairing handler, regardless of the wireless technology employed by a device. The framework provides an aggregation of wireless technologies into a common user interface, improving the user's experience and expanding possibilities for use of wireless technologies.

### BACKGROUND

Wireless channels provide a convenient means of establishing a connection between two or more devices. The variety of applications for which wireless is useful has espoused a number of standards, i.e., technologies, each directed to a certain subgroup (often overlapping) of the application space. Technologies associated with wireless personal area networks (PANs) and local area networks (LANs) are commonly used by consumers currently, and wireless metropolitan area networks (MANs) and wide are networks (WANs) are also known.

Even within in these network classes, multiple technologies may be available. For example, Bluetooth, IrdA, UWB (ultra-wide band), and ZigBee (IEEE 802.15.4) are all considered Wireless PAN technologies. Bluetooth for example is frequently employed to connect wireless handsets to a cellular phone. Across these groups, different technologies may be used and a single computing device may be equipped to operate with more than one technology. Wi-Fi (IEEE 802.11) may be used for wireless LANs. A computer may be equipped with both Wi-Fi and Bluetooth, for example, to support functions over a LAN and over a PAN.

While each technology is ultimately aimed at transmitting information over a wireless channel, the details of the implementation can vary significantly. Each wireless technology uses specific software designed to establish a wireless connection, with another device using the specific wireless technology. The software may manage and perform a pairing process.

For each technology these steps include a discovery phase and a pairing phase. In the discovery phase a wireless devices becomes aware of the presence of a second wireless device. In the pairing phase a connection is established when the wireless devices successfully exchange authorization information in a pairing ceremony. The details of the discovery and pairing phases may be specific to each technology.

### SUMMARY OF INVENTION

The inventors have recognized and appreciated that the variety of wireless technologies with which a user must be familiar, and the possibility that different technologies require different pairing ceremonies, can deter use of wireless technologies and instead has prompted users to find alternative approaches for exchanging information. More effective use of a wireless computer may be facilitated be providing the computer with a framework that facilitates providing a consistent user experience during pairing of a user of a wireless-enabled computer, regardless of a technology to be used. The framework may also reduce the complexity of developing software to manage the pairing process, facilitating addition of new wireless technologies to computers.

The framework includes technology-specific pairing handler modules and technology-independent ceremony modules. Each pairing handler module may communicate with devices using a specific wireless technology. Each ceremony module may be adapted to interact with a user as part of the exchange of the information during a certain type or certain portion of a pairing ceremony. Each pairing handler module may invoke one or more ceremony modules to perform a pairing ceremony.

The framework, and its use, provide the aggregation of wireless technologies under a common user interface format. Because the user experience of pairing wireless devices is similar regardless of the wireless technology, the burden to the user is reduced and the opportunities for use of wireless technologies are expanded.

The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a structure of an operating environment in which a primary wireless device may be connected to one or more secondary wireless devices according to an embodiment of the invention;

FIG. 2 is a program architecture according to some embodiments;

FIG. 3 is a flow chart illustrating a method of unified pairing;

FIG. 4 shows a mapping of technology specific error codes to unified pairing error codes and associated mitigation steps;

FIG. 5A-5C show images of a user interface according to some embodiments;

FIG. 6A-6C show images of a user interface according to some embodiments; and

FIG. 7A-7B show images of a user interface according to some embodiments.

### DETAILED DESCRIPTION

To facilitate the use of wireless technologies a wireless-enabled computer may be equipped with a framework that facilitates pairing with one or more wireless devices. The framework includes ceremony modules that manage user interactions during all or portions of pairing ceremonies. As a result, user interactions that control the wireless-enabled computer to pair with other devices are similar, regardless of the technology used for communication, eliminating the need for a user to have intimate knowledge of each wireless technology and/or the steps or programs used for pairing devices utilizing each wireless technology.

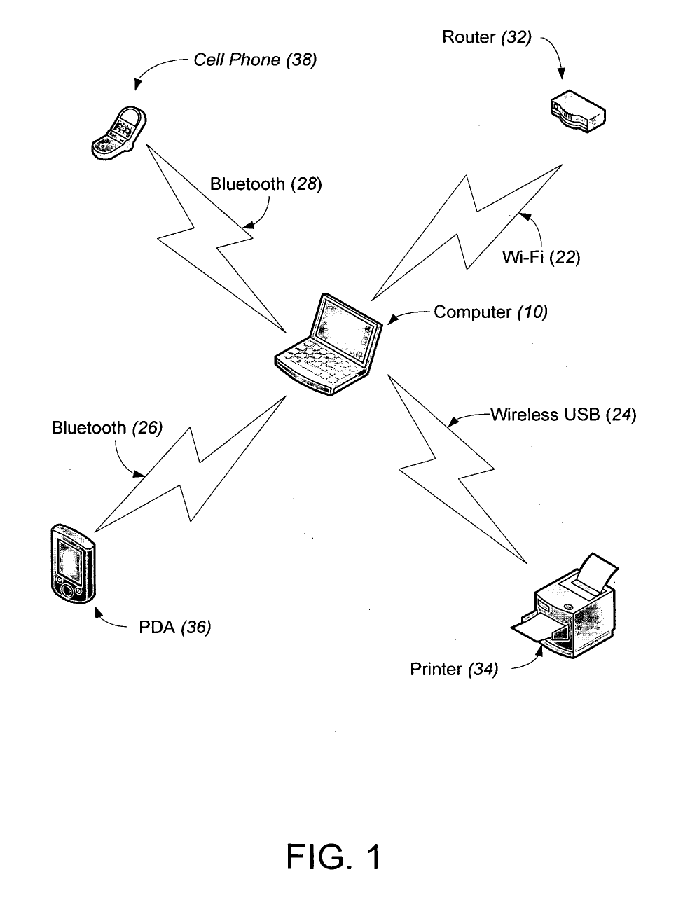

FIG. 1 illustrates an environment in which such a framework may operate. A user desiring to pair a primary wireless device 10 and one or more secondary wireless devices may oversee and contribute to the pairing through a user interface present on the primary wireless device 10. In the illustrated embodiment, the primary wireless device may be a laptop computer as illustrated in FIG. 1. However, primary device may be any electronic device configured for wireless communication, including a desktop computer, a portable electronic device or an other suitable device. Likewise, each secondary device may be any suitable wireless-enabled computing device, such as router 32, printer 34, PDA 36 and cell phone 38 illustrated in FIG. 1.

In the example of FIG. 1, primary wireless device 10 includes a framework according to an embodiment of the invention. Alternatively or additionally, one or more of the secondary wireless devices may include a framework according to embodiments of the invention. Regardless of which device or devices includes the framework, a user interface provided by the framework enables a unified user experience for pairing wireless devices, regardless of the specific wireless technology. Through the framework, a user is able to pair devices of any supported wireless technology. In addition, the user need not personally identify a specific wireless technology supported by both the primary device and a secondary device for which pairing is desired. Rather, identification of the wireless technology may be performed through the software itself, and all available devices may be aggregated and presented to the user for selecting a device with which to initiate pairing. Moreover, the user experiences a straightforward pairing process that is similar each time, regardless of the specific wireless technologies of the devices to be paired.

For pairing according to some embodiments, devices are first discovered. Discovered devices are presented to the user of the primary device. Second, based on the presentation of the devices, a user selects a device with which to pair. The user may then be prompted to provide authenticating information or other information used in a pairing ceremony with the selected device. Third, the authentication information is validated and/or other information is exchanged with the selected device and the pairing is complete. The pairing allows a connection to the selected device to be established at any time without requiring further user intervention.

Primary wireless device 10 may be embodied by any computing device capable of forming a wireless connection and having suitable processing capabilities. For example, primary wireless device 10 may be embodied as a desktop computer, a laptop computer, a tablet computer, a rack-mounted computer, a PDA, a smart phone or any other suitable portable or fixed electronic device. Secondary wireless devices likewise may be embodied by any computing device capable of forming a wireless connection such as a computer or electronic peripheral device.

To enable a unified user experience, a framework with a modular software architecture may be adopted. The framework may include discovery modules for discovering and collecting basic information on secondary wireless devices and pairing handlers for handling the pairing process associated with each wireless technology. Further, pairing ceremony modules may be included to present and/or prompt the user for pairing information. The pairing ceremony modules may be generic, and independent of the wireless technology, to ensure a consistent user experience when entering and/or receiving pairing information.

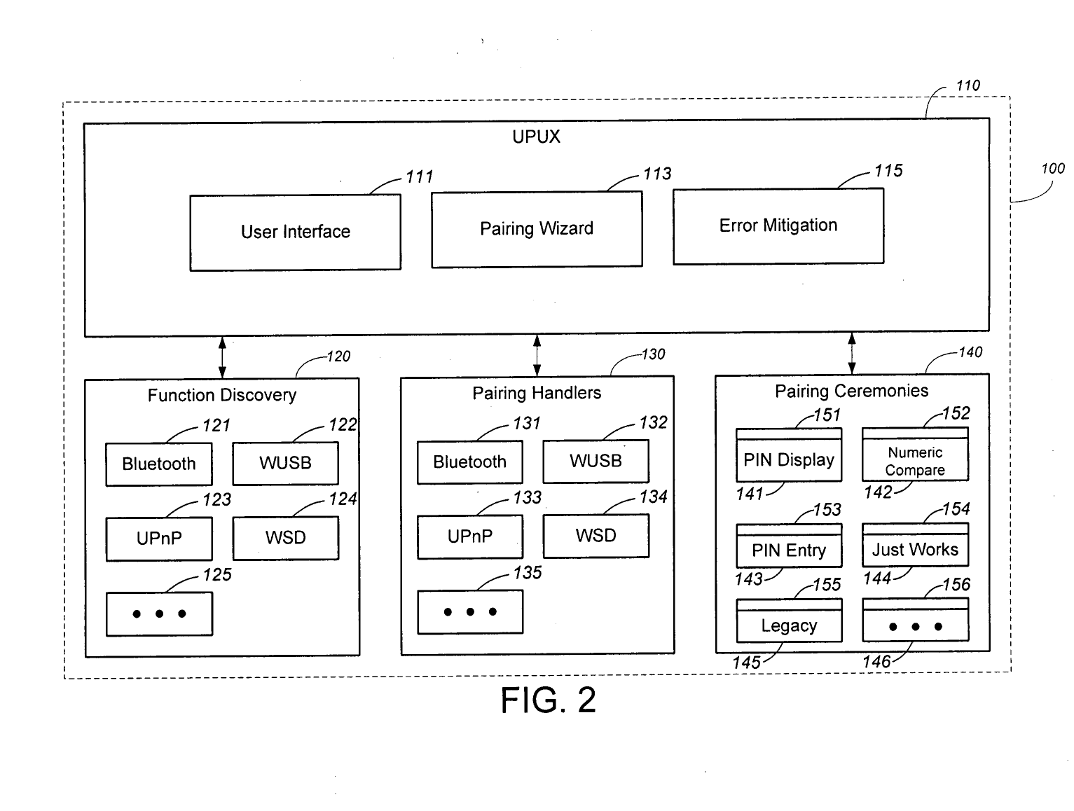

FIG. 2 illustrates the architecture 100 of a unified pairing program residing on the primary device 10 (FIG. 1) according to some embodiments. The architecture may include components, such as a unified pairing user experience component (UPUX) 110, function discovery module 120, pairing handlers 130, and pairing ceremony modules 140. These components may be implemented in any suitable way, including through the use of programming languages and programming practices as known in the art.

In the embodiment illustrated, UPUX 110 provides overall control of the pairing process and may be invoked in any suitable way, such as in response to a user input indicating that the user wishes to connect to a remote device or user input indicating that the user wishes to perform a function accessible through a remote device. UPUX 110 may include one or more modules to perform one or more functions or sub-functions associated with pairing of one or more devices with primary device 10.

In the embodiment illustrated, UPUX 110 may include a user interface module 111 that presents a user interface for overall control of the pairing and for user interactions that may not be otherwise controlled by other components of UPUX 110.

UPUX 110 may also include an error mitigation tool 115. Such a tool may present to a user messages when errors are detected during pairing, regardless of the technology with which pairing was attempted. The tool may also guide a user with mitigation steps. This information may be presented in a fashion that provides a common user experience for overcoming errors common to multiple wireless technologies, as described in more detail below in conjunction with FIG. 4.

UPUX 110 may further include a Pairing Wizard 113 to facilitate pairing. Pairing Wizard 113 may be programmed to interact with a user to present choices to the user and receive user input as the user performs a pairing process, including the discovery and pairing phase of the pairing process. Pairing Wizard 113, and other components of the framework, may interact with other components of the framework to perform pairing-related functions.

The framework may include other components, such as associated function discovery 120, pairing handlers 130, and pairing ceremonies 140. Function discovery 120 provides technology-specific discovery provider modules 121-125 for discovering and collecting basic information on secondary wireless devices, such as router 32, printer 34, PDA 36 and cell phone 38 in FIG. 1, within communications range of primary device 10. Each discovery provider module 121-125 is associated with a specific technology such as module 121, which is associated with Bluetooth, module 122, which is associated with WUSB, module 123, which is associated with UPnP, and module 124, which is associated with WSD, and module 125, for which a technology is not specifically identified in the example of FIG. 2, but may be associated with any other wireless technology, whether now known or hereafter developed. The specific technologies are purely exemplary and may or may not be present in a given implementation. Also, in some embodiments a generic discovery provider module and/or discovery provider modules may be associated with multiple wireless technologies.

Each technology-specific discovery provider module may be programmed to perform steps needed to identify a secondary device in communication range with the primary device available for connection using the specific technology. For example, according to some wireless protocols, devices available for connection may respond to beacon signals or may periodically broadcast their availability. Regardless of the specific mechanism used by each wireless technology, a technology-specific discovery provider module is programmed to control a wireless network interface and other components of the primary device to perform steps to identify secondary devices.

Pairing handlers 130 include technology-specific pairing handler modules 131-135 for communicating with secondary devices using a corresponding wireless technology. Pairing handler modules 131-135 are shown associated with specific technologies, such as module 131, which is associated with Bluetooth, module 132, which is associated with WUSB, module 133, which is associated with UPnP, and module 134, which is associated with WSD, and module 135, for which a technology is not specifically identified in the example of FIG. 2, but may be associated with any other wireless technology, whether now known or hereafter developed. The specific technologies are purely exemplary and may or may not be present in a given implementation. In some embodiments, a generic pairing handler module and/or pairing handler modules are associated with multiple wireless technologies.

Pairing ceremonies 140 comprises of a variety of generic pairing ceremony modules 141-146, each with an associated ceremony interface 151-156. The pairing ceremony modules provide a mechanism to present information to or receive information from a user relating to pairing. When invoked, each ceremony module may present a user interface. The user interface may provide information to the user based on parameters passed to a ceremony module through its associated interface. The user interface may also collect information from the user and return that information through its associated interface.

In the embodiment illustrated, the ceremony modules are not technology-specific. Rather, each ceremony module is coded to interact with a user during a specific type of ceremony or a specific portion of a pairing ceremony. These generic ceremonies or portions of ceremonies may be used alone or in combination in pairing ceremonies for any wireless technology.

The pairing ceremony modules may be invoked, either directly or indirectly, by pairing handlers 130. As part of the process for pairing the primary device and a given secondary device, the associated pairing handler module may specify one or more pairing ceremonies be performed. Because the pairing ceremonies are generic, any pairing handler module can invoke any pairing ceremony module. Any suitable inter-module communication techniques may be employed. In some embodiments, the pairing ceremony module is invoked by the pairing handler module through the associated ceremony interface. In some other embodiments the pairing handler invokes a pairing ceremony through UPUX 110. The pairing handler may specify a pairing ceremony in response to a request from the UPUX 110, which then interfaces with the pairing ceremony module through the associated ceremony interface. Generic pairing ceremonies further partition the user experience from the specific details of the wireless technology.

Users may be required to participate in multiple pairing ceremonies. A pairing handler module may utilize a decision tree which can repeat a ceremony or present another ceremony as a result of the feedback from a previous ceremony and/or some state. This state may, for example, be associated with a device or a heuristic.

As a specific example, in the environment of FIG. 1, a user of primary wireless device 10 may wish to pair to cell phone 38 (FIG. 1). Pairing wizard 113 may invoke a Bluetooth function discovery module to identify cell phone 38 or may invoke multiple available function discovery modules and present to a user a list of available devices, regardless of technology, including cell phone 38. Regardless of how cell phone 38 is discovered, the user may input a command selecting this device for pairing.

The Bluetooth pairing handler module 131 may then be called to establish the connection. If during the pairing process, the Bluetooth pairing handler module 131 determines a pass code must be entered by the user to validate the connection, the Bluetooth pairing handler module 131 invokes pairing ceremony module 143, “PIN Entry,” through ceremony interface 153. Pairing ceremony module 143 causes the user interface to prompt the user for a PIN. Once entered by the user, the data is passed back to the Bluetooth pairing handler module 131. If the PIN is accepted, additional pairing ceremonies may follow or the connection 28 (FIG. 1) may be established.

Other pairings may be formed in a similar way. For example, primary wireless device 10 may establish: Wi-Fi connection 22 with router 32, WUSB connection 24 with printer 34, and Bluetooth connection 26 with PDA 36. Though each pairing process may be different, common portions may have a common user interface format because the user interface is driven by pairing ceremonies 140, regardless of the wireless technology.

Referring again to FIG. 2, pairing ceremony modules 141-145, along with associated ceremony interfaces 151-155 are shown associated with specific pairing ceremonies. These specific pairing ceremonies are purely exemplary and may or may not be present in a given implementation. Reference blocks 146 and 156 represent any number of pairing ceremony modules and the associated ceremony interfaces, respectively.

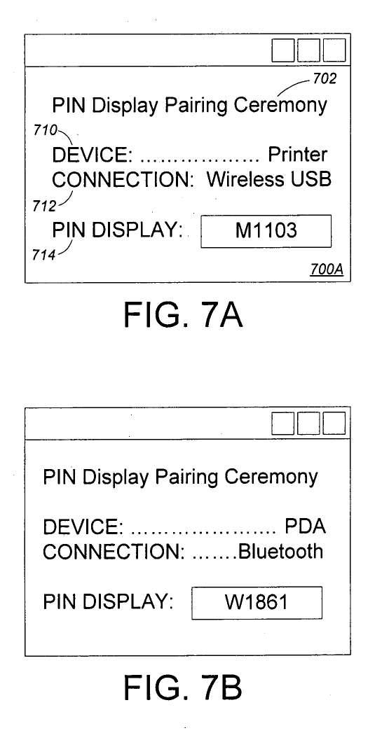

The PIN Display pairing ceremony module 141 presents a PIN in the user interface. Through this interface, a user may be prompted to enter the PIN into the secondary device so that the primary device may authenticate the device as the specific device with which the user is attempting to pair. FIGS. 7A-7B illustrate example user interfaces associated with some embodiments of a PIN Display pairing ceremony.

The Numeric Compare pairing ceremony module 142 presents a code in the user interface. The same code may be a code that should appear on a display of the secondary device as part of a pairing ceremony. Through such a user interface, a user may be requested to verify if the identical code appears on the secondary device that is the target of the pairing and to input an indication of whether the code identical code appears on the secondary device.

The PIN Entry pairing ceremony module 143 may present a user interface prompting the user to enter a PIN through the user interface. This PIN may be a secret password or a number specific to the secondary device such as a serial number.

The Just Works pairing ceremony module 144 may provide a user interface when no user input is required.

The Legacy pairing ceremony module 145 presents a user interface that allows the user to select a pairing ceremony to be performed. User selection of pairing ceremonies may be useful, for example, when the pairing handler module is unable to determine from the secondary device which pairing ceremony to perform.

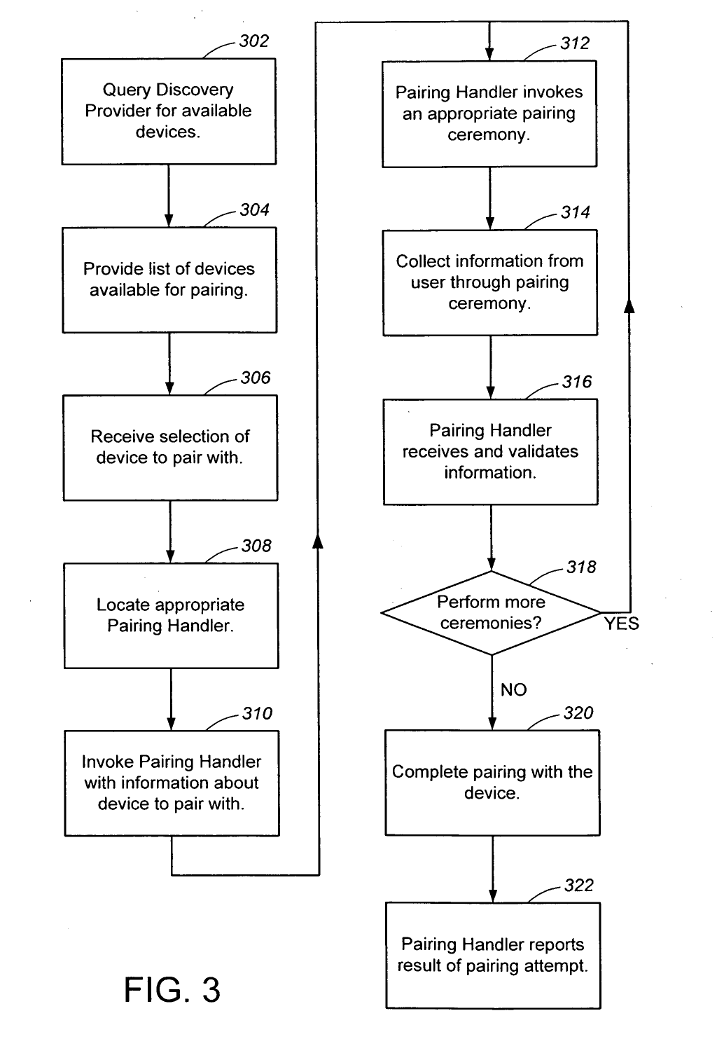

With reference to FIG. 3, a method of pairing wireless devices is disclosed. Such a method may be implemented, for example by the Pairing Wizard 113 (FIG. 2) in UPUX 110, which may invoke other components of the framework.

In step 302, discovery providers are queried for available secondary devices. In architecture 100 (FIG. 2) this step may be performed by UPUX 110 requesting function discovery 120 to query some or all of discovery provider modules 121-125 and to return results to UPUX 110. Discovery provider modules 121-125 may search for devices in advance of a user initiating an action that triggers pairing. Though, such a search may be triggered by such an action or may be performed at any other suitable time.

In step 304 secondary devices available for pairing are identified. The devices may be identified by a list assembled by UPUX 110 of devices found by one or more discovery provider modules. In architecture 100 (FIG. 1), UPUX 110 may organize the results in any suitable way for presentation via the user interface. The results may be organized by device type, device name, wireless technology, or any other feature that may be ascertained by the discovery provider modules.

In step 306, a user selection of a secondary device for pairing is received. In some embodiments, a user may select multiple devices for pairing. In that case, steps 308 through 322 may be performed for each selected device.

In step 308 a pairing handler module appropriate for the selected device is located. In architecture 100 (FIG. 2), discovery provider 120 provides to UPUX 110 an object associated with each identified device. This object may include information from which a wireless technology used by the device may be identified. Based on this information, Pairing Wizard 113 may identify which of pairing handler modules 121-125 is appropriate. However, any suitable mechanism to locate an appropriate pairing handler may be used. For example, the discovery provider module that identified the selected secondary device may indicate to UPUX 110 which of pairing handler modules 121-125 is appropriate.

In step 310, the appropriate pairing handler is invoked and information about the selected device is passed to it. That information may be in the form of the object provided by a discovery provider module, but any suitable form may be used.

In step 312, the pairing handler determines which pairing ceremony is appropriate. In some embodiments, the pairing ceremony or ceremonies used for pairing with a device using a particular wireless technology are predetermined by the protocol of the wireless technology. Accordingly, a pairing ceremony may be identified in the coding for the pairing handler. In some embodiments, multiple pairing ceremonies may be designated.

Alternatively or additionally, a specific pairing ceremony applicable at a point in time may depend on the state of the secondary device. Moreover, a pairing ceremony may receive input, which is in turn based on the state of the device or other information that was not collected by a discovery provider module. Also, the timing of executing of a pairing ceremony may depend on prior interactions with the secondary device Accordingly, processing at block 312 may entail interactions between the primary and secondary devices, which may be performed under the control of the pairing handler before the specific pairing ceremony may be identified or invoked. In architecture 100 (FIG. 2), the information used in invoking an appropriate pairing ceremony may be passed from the pairing handler module through UPUX 110. However, any suitable inter-module communication techniques may be employed.

In step 314, a ceremony module identified in step 312 is invoked. The ceremony module may render a user interface for display of information about the pairing process to the user. Also, the ceremony module may collect information from the user through a user interface corresponding to the designated pairing ceremony. Though, as described above, some ceremonies, such as “Just Works” do not entail user input, and depending on the specific pairing ceremony is invoked, no information may be collected at step 314. If multiple pairing ceremonies are designated in step 312, they may be presented simultaneously and/or sequentially.

In step 316, information collected from the user at step 314 may be passed to the pairing handler. In an architecture in which ceremony modules are called through ceremony interfaces, such as 151 . . . 156, collected information may be returned through that interface. Though, any suitable mechanism may be used to provide information representing user inputs. Moreover, the types of information provided by a ceremony module need not be limited to just user input. A ceremony module may track time between events or other status information, and may report such information instead of or in addition to user input information.

In some pairing ceremonies, user input information may be validated, such as by comparing user information with presorted codes. Such processing may also be performed at step 316. In the embodiment illustrated, such validation may be performed within the pairing handler. However, any suitable type of validation may be performed and processing to perform that validation may be performed within any suitable component.

In step 318, a decision is made if an additional pairing ceremony is required. This decision may also be made within the pairing handler. An additional ceremony, for example, may be required if the information collected from the user was invalid, if multiple pairing ceremonies were designated in step 312 and information for each was not collected in step 314, or if based on the state of the secondary device, further steps in the pairing process are required. If an additional ceremony is to be performed, the method returns to step 312, where a sub-process of invoking additional ceremony modules is repeated.

In step 320, pairing with the device may be completed. The specific functions performed at step 320 may depend on the specific wireless technology. But, examples of the functions that may be performed may include creating a data structure holding information about the connection to the secondary device, invoking an adapter to manage the connection or taking other action that completes the pairing process.

In step 322, the pairing handler reports the results of the attempt to pair. In architecture 100, the result may be reported from the pairing handler module to UPUX 110 for display to the user or otherwise used within a computer system for reporting or diagnosis. If the pairing handler module fails to pair with the device, the report may include an error code. This error code can be used to implement and/or suggest mitigation steps to the user to overcome the failure.

With reference to FIG. 4, in some embodiments, UPUX 110 may contain an error mitigation tool 115 (also shown in FIG. 2). The error mitigation tool 115 provides a common user experience for overcoming errors of the same type across each wireless technology. When a pairing handler module encounters an error during the pairing process, a technology specific error code may be generated. The pairing handler may map the technology specific error code to a unified pairing error code (UPEC) so that mitigation steps, corresponding to the UPEC code may be performed and/or presented.

Unified pairing error codes 460 may be defined by the error mitigation tool. Each unified pairing error code may be an error code correspond to a specific type of error. For example, errors may correspond to faults associated with hardware, software, invalid user input, and the like.

Each error code 460 may have an associated set of proposed mitigation steps 470. The mitigation steps 470 are used for error handling. These mitigation steps may be executable programming constructs and/or output to the user containing recommendations when an error is encountered. For example, when error code UPEC 461 is designated, mitigation step 471 through mitigation step 472 may be performed and/or presented. In some embodiments, the mitigation steps may have a linear or tree architecture, although any appropriate method may be used for selecting the order of execution of mitigation steps.

Several example pairing handler modules (131-134) are shown along with error codes. Each wireless technology may have its own set of technology specific error codes 400. The Bluetooth pairing handler module, for example, is illustrated having a set of error codes including 401, 402, 403, and 404.

Architecture 100 may contain a mapping 450 from the technology specific error codes 400 to the unified pairing error codes 460. This mapping may be implemented within each pairing handler module or may be implemented within error mitigation module 115. In FIG. 4 exemplary pairing handler modules 131, 132, and 133 implement a mapping. Each of error codes 401, 412, and 421 map to unified pairing error code 462. When the unified pairing error code 462 is identified by a pairing handler module through an appropriate interface, mitigation step 473 through mitigation step 474 are performed and/or presented to the user.

Because each wireless technology is prone to many of the same types of errors, the same mitigation steps may be applied to overcome errors of the same type, even for different wireless technologies. Thus a user may have a consistent user experience when troubleshooting pairing errors, regardless of the specific wireless technology of the devices the user is attempting to pair.

Note that not all pairing handler modules need to have a error code mapping. In the example of FIG. 4, pairing module 134 does not have an error code mapping. Further, not all error codes need be mapped. For example error code 404 is not mapped to a unified pairing error code 460.

When an error code is not mapped, UPUX may not be able to employ or suggest specific mitigation steps. Rather, the technology specific error code may be presented to the user.

The mapping 450 between the pairing handlers 131-134 and error mitigation tool 115 shown in FIG. 4 is illustrative. Unified pairing error codes should be selected to correspond with common errors typical of wireless technologies.

As an example of the operation of the error mitigation tool 115 in the context of architecture 100, consider a Bluetooth pairing involving the Bluetooth pairing handler module 131. If a pairing failure occurs, the Bluetooth pairing handler module may generate an error code corresponding to the reason pairing failed. This Bluetooth error code may be mapped to a unified pairing error code by the Bluetooth pairing handler module. The UPEC code may be provided to the mitigation tool 115 which may then execute the mitigation steps corresponding to the UPEC code.

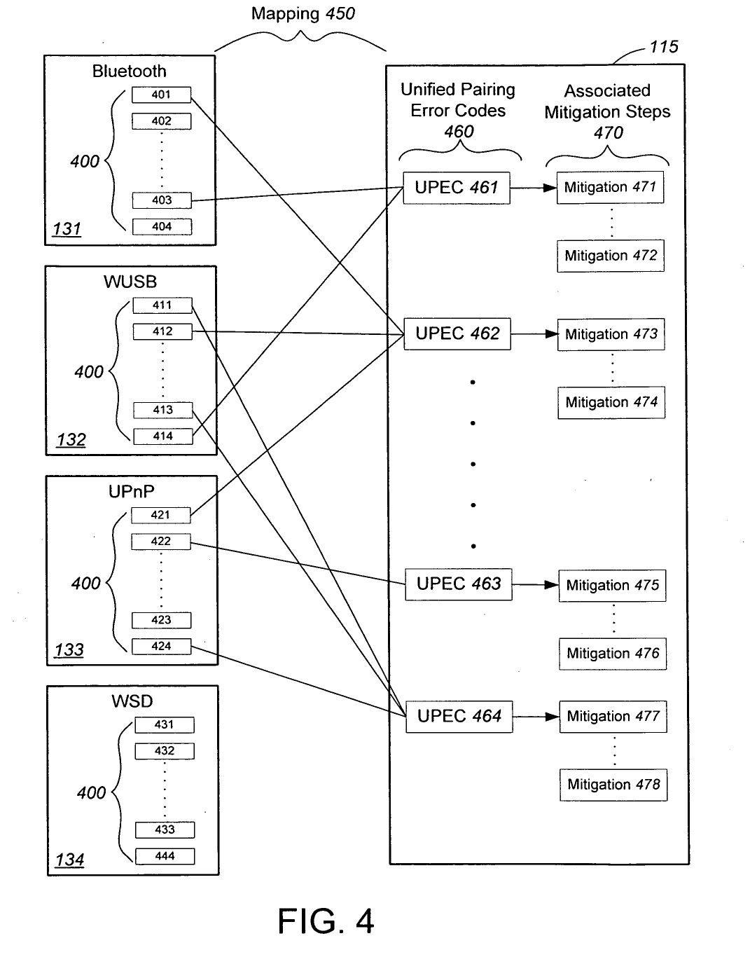

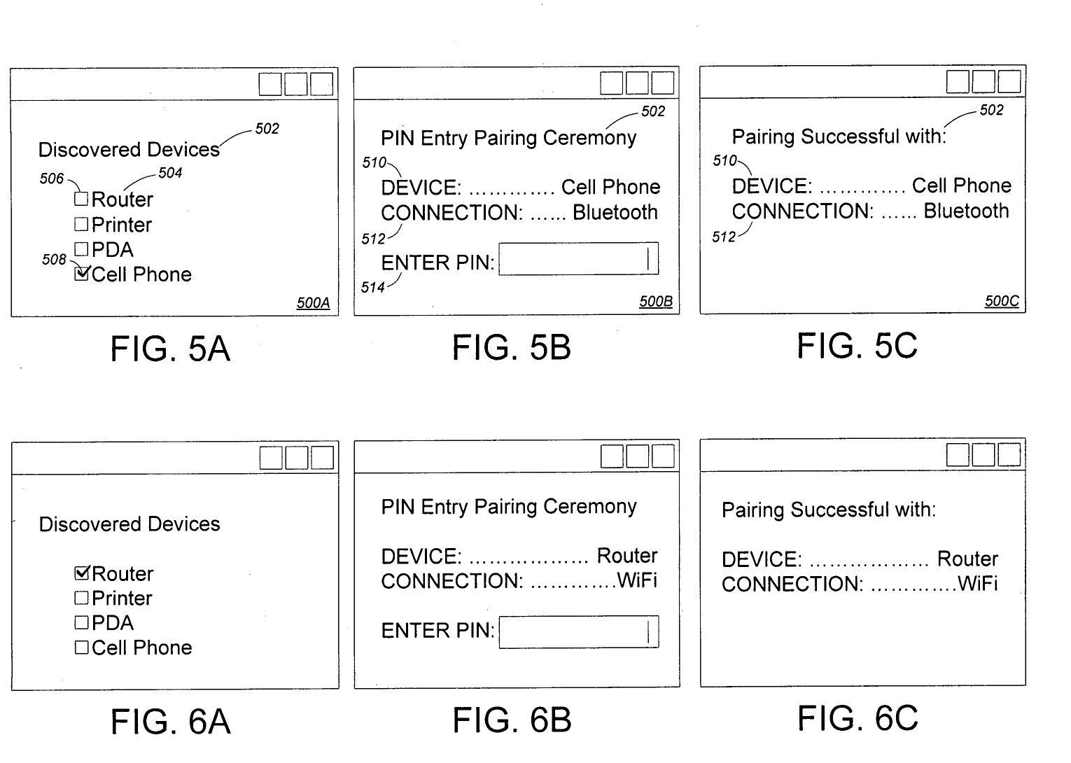

FIGS. 5A-5C and FIGS. 6A-6C illustrate a user experience according to some embodiments. As illustrated, similar dialog boxes may be presented at each step of a pairing process regardless of the specific wireless technology in use. Architecture 100 may facilitate such a unified user experience by aggregating steps for different technologies in one framework. The user interacts through a dialog box, such as may be presented on a computer display as is known in the art. The example dialog boxes shown in FIGS. 5A-5C and FIGS. 6A-6C provide a visual display of information and prompts for the user. However, the same information can take the form of any suitable user interface and is not restricted to a windows based user interface using dialog boxes. The configuration of elements in the dialog box are preferably arranged in a user friendly manner, but may be arranged in any way.

FIG. 5A illustrates a dialog box 500A, which may be rendered by Pairing Wizard 113 at the end of a discovery phase. Through such an interface, a user may receive a list of discovered devices and select a device for pairing. In the state illustrated, the user has selected cell phone 38 (FIG. 1) for pairing. The elements in the configuration of dialog box 500A comprises a title 502, a list of discovered devices 504, selection boxes 506, and a user selection 508. Here, each of the secondary devices 32, 34, 36, and 38 (FIG. 1) are shown to have been identified. Even those these devices use different technologies, they are aggregated in one display.

Subsequent to the selection of cell phone 38, a pairing ceremony display may be presented, such as the dialog box 500B in FIG. 5B. In this figure, the specific example of a pin entry pairing ceremony is shown. However, any pairing ceremony may be used. In the case of PIN entry, the user is required to enter information and a prompt for this information is provided. The elements in the configuration of dialog box 500B comprises a title 502, a device name 510, a wireless technology connection type 512, and a validation element 514.

Other information may be displayed at other stages in the process. For example, if the pairing is successful, the dialog box 500C of FIG. SC may be displayed to the user. The elements in the configuration of dialog box 500C comprises a title 502, a device name 510, and a wireless technology connection type 512.

FIGS. 6A-6C illustrate alternative dialog boxes that may appear if a user selects router 32 for pairing as shown in FIG. 6A. Subsequent to the selection of router 32, a pairing ceremony display may be presented as in FIG. 6B. In this figure, the specific example of a PIN entry pairing ceremony is shown. Because the pairing ceremonies are; generic, and not specific to any one technology, the configuration of the user interface is very similar to that shown in FIG. SA. If the pairing is successful, the dialog box of FIG. 6C may be displayed to the user.

The user experience for the pairing illustrated in FIGS. 5A-5C may be the same as the user experience for the pairing illustrated in FIGS. 6A-6C. The aggregation of wireless technologies under a single architecture allows a universal configuration and user experience, regardless of the device type or wireless technology.

FIGS. 7A-7B illustrate a dialog box showing a PIN Display pairing ceremony for a Wireless USB printer and Bluetooth PDA, respectively, further illustrating that configuration of the dialog box is independent of the device or technology. The elements in the configuration of dialog box 700 comprises a title 702, a device name 710, a wireless technology connection type 712, and a validation element 714.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable medium (or multiple computer readable media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A computer storage medium comprising computer executable modules, the modules comprising:
a plurality of ceremony modules, each ceremony module for interacting with a user during at least a portion of a pairing ceremony; and
at least one pairing handler module, each pairing handler module for performing a pairing ceremony by communicating with a wireless device and communicating with a user through a designated ceremony module of the plurality of ceremony modules.

2. The computer storage medium of claim 1, wherein the plurality of ceremony modules comprises a PIN entry and/or PIN display ceremony module.

3. The computer storage medium of claim 1, wherein the plurality of ceremony modules comprises a Just Works ceremony module.

4. The computer storage medium of claim 1, wherein the plurality of ceremony modules comprises a numeric compare ceremony module.

5. The computer storage medium of claim 1, wherein:
the at least one pairing handler modules comprises a first pairing handler module and a second pairing handler module; and
the designated ceremony module is designated by the first pairing handler and the second pairing handler module.

6. The computer storage medium of claim 1, wherein:
the designated ceremony module is a first designated ceremony module; and
the at least one pairing handler modules comprises a pairing handler module that designates the first designated ceremony module and designates a second designated ceremony module.

7. The computer storage medium of claim 1, wherein each ceremony module comprises a programming interface for communicating with the at least one pairing handler module and/or a user experience component.

8. The computer storage medium of claim 1, wherein the at least one pairing handler module comprises a plurality of pairing handler modules and the computer storage medium further comprises:
an error mitigation module for receiving an error code from each of the plurality of pairing handler modules and presenting the user proposed mitigation steps.

9. A method of operating a computer to connect to a wireless device, the method comprising:
receiving a selection of the wireless device, the wireless device connectable to the computer using a wireless technology;
invoking a pairing hander based on the wireless technology of the wireless device;
invoking by the pairing handler at least one pairing ceremony; and executing the at least one invoked pairing ceremony, the executing comprising presenting a user interface to a user.

10. The method of claim 9, further comprising:
mapping a technology specific error code to a unified pairing error code.

11. The method of claim 10, further comprising:
presenting and/or performing mitigation steps corresponding to the unified pairing error code.

12. The method of claim 9, further comprising:
validating a user input received during the execution of the at least one pairing ceremony.

13. The method of claim 12, wherein:
the at least one pairing ceremony comprises a first pairing ceremony and a second pairing ceremony; and
the pairing handler invokes the second pairing ceremony in response to the validating.

14. The method of claim 9, wherein invoking the at least one ceremony comprises invoking a plurality of ceremonies in succession.

15. The method of claim 9, wherein invoking the at least one ceremony comprises invoking a ceremony module from a set of ceremony modules, the set comprising a PIN entry ceremony module and a PIN display ceremony module.

16. A method comprising:
displaying, in response to a first selection of a first wireless device utilizing a first wireless technology, a first dialog box, the first user interface having a configuration for exchanging information with a user relating to a pairing ceremony; and
displaying, in response to a second selection of a second wireless device utilizing a second wireless technology, a second user interface, the second dialog box having the configuration.

17. The method of claim 16, wherein the configuration comprises a wireless technology element.

18. The method of claim 16, wherein the configuration comprises a device type element.

19. The method of claim 16, wherein the configuration comprises a validation element.

20. The method of claim 19, wherein:
the displaying, in response to the first selection, a first content of the validation element is designated by a first pairing handler, the first pairing handler corresponding to the first wireless technology and the displaying, in response to the second selection, a second content of the validation element is designated by a second pairing handler, the second pairing handler corresponding to the second wireless technology.
